(19) United States
(12) Patent Application Publication
(10) Pub. No.: US 2025/0185105 A1
(43) Pub. Date: Jun. 5, 2025

(54) TECHNIQUES FOR MAINTAINING BEAM INFORMATION IN AN INACTIVE STATE

(71) Applicant: QUALCOMM Incorporated, San Diego, CA (US)

(72) Inventors: Yehonatan DALLAL, Kfar Saba (IL); Shay LANDIS, Hod Hasharon (IL); Idan Michael HORN, Hod Hasharon (IL)

(21) Appl. No.: 18/719,736

(22) PCT Filed: Jan. 27, 2023
(86) PCT No.: PCT/US2023/061451

§ 371 Date: Jun. 13, 2024

(30) Foreign Application Priority Data
Feb. 18, 2022 (IL) 290724

(51) Int. Cl. H04W 76/27; H04B 7/06; H04W 24/08; H04W 60/00; H04W 68/00

(52) U.S. Cl. CPC H04W 76/27; H04B 7/06952; H04W 24/08; H04W 60/00; H04W 68/00

(57) ABSTRACT

Methods, systems, and devices for wireless communication are described to support techniques for an additional inactive state at a user equipment (UE). When in a connected state, a serving network device for the UE may transmit an indication for the UE to enter the inactive state. Based on the indication the UE may maintain beam information at the UE, and the wireless communications network may also maintain the beam information. The UE and the wireless communications network may also maintain one or more other contexts or states, such as a registration management state and a connection management state. Based on the beam information maintained in the inactive state, the wireless communication network may transmit paging messages for the UE via one or more beams indicated by the beam information, while the UE is in the inactive state.

### CROSS REFERENCE

The present application is a 371 national stage filing of International PCT Application No. PCT/US2023/061451 by Dallal et al., entitled “TECHNIQUES FOR MAINTAINING BEAM INFORMATION IN AN INACTIVE STATE,” filed Jan. 27, 2023; and claims priority to Israel Patent Application No. 290724 by Dallal et al., entitled “TECHNIQUES FOR MAINTAINING BEAM INFORMATION IN AN INACTIVE STATE,” filed Feb. 18, 2022, each of which is assigned to the assignee hereof, and each of which is expressly incorporated by reference in its entirety herein.

### FIELD OF TECHNOLOGY

The following relates to wireless communication, including techniques for maintaining beam information in an inactive state.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some cases, a UE may temporarily suspend communications with a wireless communications network based on entering a low power mode. For example, the UE may enter the low power mode and may monitor for paging messages from the wireless communications network according to a paging periodicity.

### SUMMARY

The described techniques relate to improved methods, systems, devices, and apparatuses that support techniques for maintaining beam information in an inactive state. Generally, the described techniques provide for an additional radio resource control (RRC) inactive state (e.g., an inactive state) at a user equipment (UE). That is, two inactive states may be defined for a UE which is registered and connected to the network over RRC. In a first inactive state the UE and a wireless communications network (e.g., one or more base stations, one or more network devices, a core network) may retain beam information for the UE, in addition to other information (e.g., a connection management state, a registration management state). When in an RRC connected state, a serving base station (e.g., network device) for the UE may transmit an indication for the UE to enter the first inactive state. Based on the indication the UE may maintain beam information at the UE (e.g., a last beam used, an orientation of the UE, one or more wireless communication states), and the wireless communications network (e.g., one or more base stations, network devices, the core network) may also maintain the beam information, and in some cases may maintain additional or alternative beam information. The UE and the wireless communications network may also maintain one or more other contexts or states, such as a registration management state and a connection management state. Based on the beam information maintained in the first inactive state, the wireless communication network may transmit paging messages for the UE via one or more beams indicated by the beam information, while the UE is in the inactive state. In accordance with network or UE activity, the UE may transition from the first inactive state back to the RRC connected state or to a second inactive state in which beam information is released or otherwise no longer retained.

A method for wireless communication at a UE is described. The method may include receiving, from a network device, an indication to enter an inactive state for RRC communications with a wireless communications network, the inactive state associated with maintaining a registration management state, a connection management state, and beam information for the UE at the wireless communications network, entering the inactive state based on receiving the indication, where entering the inactive state includes retaining the beam information at the UE, and monitoring, within the inactive state, for one or more paging messages from the wireless communications network according to the beam information.

An apparatus for wireless communication at a UE is described. The apparatus may include a processor and a memory coupled with the processor, where the memory includes instructions executable by the processor. The instructions may be executable by the processor to cause the apparatus to receive, from a network device, an indication to enter an inactive state for RRC communications with a wireless communications network, the inactive state associated with maintaining a registration management state, a connection management state, and beam information for the UE at the wireless communications network, enter the inactive state based on receiving the indication, where entering the inactive state includes retaining the beam information at the UE, and monitor, within the inactive state, for one or more paging messages from the wireless communications network according to the beam information.

Another apparatus for wireless communication at a UE is described. The apparatus may include means for receiving, from a network device, an indication to enter an inactive state for RRC communications with a wireless communications network, the inactive state associated with maintaining a registration management state, a connection management state, and beam information for the UE at the wireless communications network, means for entering the inactive state based on receiving the indication, where entering the inactive state includes retaining the beam information at the UE, and means for monitoring, within the inactive state, for one or more paging messages from the wireless communications network according to the beam information.

A non-transitory computer-readable medium storing code for wireless communication at a UE is described. The code may include instructions executable by a processor to receive, from a network device, an indication to enter an inactive state for RRC communications with a wireless communications network, the inactive state associated with maintaining a registration management state, a connection management state, and beam information for the UE at the wireless communications network, enter the inactive state based on receiving the indication, where entering the inactive state includes retaining the beam information at the UE, and monitor, within the inactive state, for one or more paging messages from the wireless communications network according to the beam information.

Some examples of the method, apparatuses, and non-transitory computer-readable medium described herein may further include operations, features, means, or instructions for changing from the inactive state to a second inactive state that may be associated with maintaining the registration management state and the connection management state for the UE at the wireless communications network, where changing from the inactive state to the second inactive state includes releasing the beam information at the UE.

Some examples of the method, apparatuses, and non-transitory computer-readable medium described herein may further include operations, features, means, or instructions for determining a change in location of the UE or a change in a beam of the UE and transmitting, to the network device, an indication of the change in the location of the UE or the change in the beam of the UE based on determining the change in location or beam, where changing from the inactive state to the second inactive state may be based on transmitting the indication of the change in location or beam to the network device.

Some examples of the method, apparatuses, and non-transitory computer-readable medium described herein may further include operations, features, means, or instructions for changing from the inactive state to the second inactive state may be based on a value of a timer associated with the inactive state.

Some examples of the method, apparatuses, and non-transitory computer-readable medium described herein may further include operations, features, means, or instructions for changing from the second inactive state to an active state for RRC communications with the wireless communications network.

Some examples of the method, apparatuses, and non-transitory computer-readable medium described herein may further include operations, features, means, or instructions for changing from the inactive state to an active state for RRC communications with the wireless communications network.

Some examples of the method, apparatuses, and non-transitory computer-readable medium described herein may further include operations, features, means, or instructions for receiving, after changing from the inactive state to the active state, a downlink transmission from the wireless communications network based on the beam information retained at the UE.

Some examples of the method, apparatuses, and non-transitory computer-readable medium described herein may further include operations, features, means, or instructions for entering the inactive state may be based on a movement state of the UE, a movement history of the UE, or any combination thereof.

Some examples of the method, apparatuses, and non-transitory computer-readable medium described herein may further include operations, features, means, or instructions for transmitting, to the network device, a request to enter the inactive state based on the movement state of the UE, the movement history of the UE, or any combination thereof, where receiving the indication to enter the inactive state may be based on transmitting the request to enter the inactive state.

Some examples of the method, apparatuses, and non-transitory computer-readable medium described herein may further include operations, features, means, or instructions for performing a radio access network (RAN) notification area (RNA) update with the wireless communications network while in the inactive state and updating the beam information retained at the UE based on performing the RNA update.

In some examples of the method, apparatuses, and non-transitory computer-readable medium described herein, the beam information includes an indication of one or more downlink beams for paging the UE in the inactive state.

A method for wireless communication at a network device is described. The method may include transmitting an indication for a UE to enter an inactive state for RRC communications with a wireless communications network, the inactive state associated with retaining beam information at the UE, maintaining a registration management state, a connection management state, and the beam information for the UE at the wireless communications network based on transmitting the indication to enter the inactive state, and transmitting, for the UE in the inactive state, one or more paging messages according to the beam information.

An apparatus for wireless communication at a network device is described. The apparatus may include a processor and a memory coupled with the processor, where the memory includes instructions executable by the processor. The instructions may be executable by the processor to cause the apparatus to transmit an indication for a UE to enter an inactive state for RRC communications with a wireless communications network, the inactive state associated with retaining beam information at the UE, maintain a registration management state, a connection management state, and the beam information for the UE at the wireless communications network based on transmitting the indication to enter the inactive state, and transmit, for the UE in the inactive state, one or more paging messages according to the beam information.

Another apparatus for wireless communication at a network device is described. The apparatus may include means for transmitting an indication for a UE to enter an inactive state for RRC communications with a wireless communications network, the inactive state associated with retaining beam information at the UE, means for maintaining a registration management state, a connection management state, and the beam information for the UE at the wireless communications network based on transmitting the indication to enter the inactive state, and means for transmitting, for the UE in the inactive state, one or more paging messages according to the beam information.

A non-transitory computer-readable medium storing code for wireless communication at a network device is described. The code may include instructions executable by a processor to transmit an indication for a UE to enter an inactive state for RRC communications with a wireless communications network, the inactive state associated with retaining beam information at the UE, maintain a registration management state, a connection management state, and the beam information for the UE at the wireless communications network based on transmitting the indication to enter the inactive state, and transmit, for the UE in the inactive state, one or more paging messages according to the beam information.

Some examples of the method, apparatuses, and non-transitory computer-readable medium described herein may further include operations, features, means, or instructions for updating the UE from the inactive state to a second inactive state at the wireless communications network, where updating the UE from the inactive state to the second inactive state includes releasing the beam information for the UE from the wireless communications network and maintaining the registration management state and the connection management state for the UE at the wireless communications network.

Some examples of the method, apparatuses, and non-transitory computer-readable medium described herein may further include operations, features, means, or instructions for receiving an indication of a change in a location of the UE or a change in a beam of the UE, where updating the UE from the inactive state to the second inactive state may be based on receiving the indication of the change in location or beam.

Some examples of the method, apparatuses, and non-transitory computer-readable medium described herein may further include operations, features, means, or instructions for updating the UE from the inactive state to the second inactive state may be based on a value of a timer associated with the inactive state.

Some examples of the method, apparatuses, and non-transitory computer-readable medium described herein may further include operations, features, means, or instructions for updating the UE from the second inactive state to an active state for RRC communications with the wireless communications network.

Some examples of the method, apparatuses, and non-transitory computer-readable medium described herein may further include operations, features, means, or instructions for updating the UE from the inactive state to an active state for RRC communications with the wireless communications network.

Some examples of the method, apparatuses, and non-transitory computer-readable medium described herein may further include operations, features, means, or instructions for transmitting, after updating the UE from the inactive state to the active state, a downlink transmission based on the beam information retained at the wireless communications network.

Some examples of the method, apparatuses, and non-transitory computer-readable medium described herein may further include operations, features, means, or instructions for transmitting the indication to enter the inactive state may be based on a movement state of the UE, a movement history of the UE, or any combination thereof.

Some examples of the method, apparatuses, and non-transitory computer-readable medium described herein may further include operations, features, means, or instructions for receiving a request to enter the inactive state at the UE based on the movement state of the UE, the movement history of the UE, or any combination thereof, where transmitting the indication to enter the inactive state may be based on receiving the request to enter the inactive state.

Some examples of the method, apparatuses, and non-transitory computer-readable medium described herein may further include operations, features, means, or instructions for performing a RNA update with the UE in the inactive state and updating the beam information for the UE at the wireless communications network based on performing the RNA update.

In some examples of the method, apparatuses, and non-transitory computer-readable medium described herein, the beam information includes an indication of one or more downlink beams for paging the UE in the inactive state.

### BRIEF DESCRIPTION OF THE DRAWINGS

FIG. 1 illustrates an example of a wireless communications system that supports techniques for maintaining beam information in an inactive state in accordance with aspects of the present disclosure.

FIG. 2 illustrates an example of a wireless communications system that supports techniques for maintaining beam information in an inactive state in accordance with aspects of the present disclosure.

FIG. 3 illustrates an example of a process flow that supports techniques for maintaining beam information in an inactive state in accordance with aspects of the present disclosure.

FIGS. 4 and 5 show block diagrams of devices that support techniques for maintaining beam information in an inactive state in accordance with aspects of the present disclosure.

FIG. 6 shows a block diagram of a communications manager that supports techniques for maintaining beam information in an inactive state in accordance with aspects of the present disclosure.

FIG. 7 shows a diagram of a system including a device that supports techniques for maintaining beam information in an inactive state in accordance with aspects of the present disclosure.

FIGS. 8 and 9 show block diagrams of devices that support techniques for maintaining beam information in an inactive state in accordance with aspects of the present disclosure.

FIG. 10 shows a block diagram of a communications manager that supports techniques for maintaining beam information in an inactive state in accordance with aspects of the present disclosure.

FIG. 11 shows a diagram of a system including a device that supports techniques for maintaining beam information in an inactive state in accordance with aspects of the present disclosure.

FIGS. 12 through 15 show flowcharts illustrating methods that support techniques for maintaining beam information in an inactive state in accordance with aspects of the present disclosure.

### DETAILED DESCRIPTION

A user equipment (UE) may enter and exit a connected state with a wireless communications network (e.g., with one or more base stations, one or more network devices, with a core network). The UE may exit the connected state, for example, to conserve network resources and to reduce power consumption at the UE, among other examples. The connected state may be a radio resource control (RRC) state (e.g., a state for RRC communications with the network), and may be referred to herein as an RRC connected state, or an active state. In some cases, when exiting the RRC connected state, the UE may enter an RRC idle state (e.g., an idle state), in which one or more communications contexts associated with the UE may be dropped (e.g., released, not retained or maintained) by the network. In some cases, when exiting the RRC connected state, the UE may enter an RRC inactive state, which may be an intermediate state between the RRC connected state and the RRC idle state.

In the RRC inactive state, one or more communications contexts or states associated with the UE may be maintained by the network, which may reduce latency for re-entering the RRC connected state. The contexts maintained by the wireless communications network in the RRC inactive state may include registration and connection contexts (e.g., registration management and connection management states), among other examples. In the RRC inactive state, the wireless communications network (e.g., network devices, base stations of the wireless communications network) may periodically transmit paging messages to the UE, which may be transmitted by multiple base stations (e.g., each base station using multiple beams) associated with a paging area of the UE.

In some cases, re-entering the RRC connected state from the RRC inactive state may experience some latency, for example, based on beam scanning overhead (e.g., if a total quantity of used beams is relatively high). Additionally, an amount of paging overhead while the UE is in the RRC inactive state may be relatively high, for example, based on using multiple base stations and multiple beams for paging the UE. In such cases, the overhead may result in higher resource usage by the network for paging the UE, as well as higher power usage by the UE to monitor for the paging messages.

The present disclosure provides techniques for implementing an additional RRC inactive state (e.g., a first RRC inactive state) at the UE. In the first RRC inactive state the UE and the wireless communications network (e.g., one or more base stations, the core network) may retain beam information (e.g., a beam context, a spatial context) for the UE, in addition to the other information retained by the network for the RRC inactive state (e.g., a connection management state, a registration management state). For example, in some cases, the UE may retain (e.g., maintain) a last beam used (e.g., a receive beam), an orientation of the UE (e.g., to improve an initial beam guess, in case an orientation may have changed during an inactive period), one or more states for wireless communications, or any combination thereof. In some cases, the network (e.g., a base station) may retain similar information (e.g., the same information) as the UE, and in some cases, may retain additional information.

In some cases, the first RRC inactive state may be referred to as an RRC inactive localized state, for example, based on an associated movement state of the UE (e.g., a low movement or localized state). The first RRC inactive state may additionally or alternatively be referred to as an intermediate state between the RRC inactive state (e.g., a second RRC inactive state) and the RRC connected state.

When in the RRC connected state, a serving base station for the UE may transmit an indication for the UE to enter the first RRC inactive state (e.g., based on one or more prior determinations or requests). Based on the indication the UE may maintain beam information (e.g., paging beam information) at the UE, and the wireless communications network (e.g., the base station, the core network) may also maintain the beam information. The UE and the wireless communications network may also maintain one or more other contexts or states, such as a registration management state and a connection management state. The beam information may include one beam or multiple beams (e.g., multiple adjacent beams) to be used for paging the UE, and may represent a last known beam or group of beams for downlink communications with the UE.

Based on the beam information maintained in the first RRC inactive state, paging messages for the UE may be transmitted via one or more beams indicated by the beam information, instead of being transmitted via multiple beams from multiple base stations. For example, the last serving base station may transmit one or more paging messages to the UE via one or more beams, which may be the beams indicated by the maintained beam information. Transmitting via a subset of beams (e.g., associated with one base station) may reduce paging overhead in terms of time, frequency, and/or spatial resources, among other examples, and may also reduce power consumption at the UE in the first RRC inactive state (e.g., based on monitoring for paging messages using a reduced subset of beams). The UE may move from the first RRC inactive state to the RRC inactive state (e.g., second RRC inactive state), which may include releasing the beam information stored at the UE and the network (e.g., but not releasing the other information or contexts). Additionally or alternatively, the UE may move from the first RRC inactive state to the RRC connected state.

In some cases, based on the beam information (e.g., beam context) maintained at the UE and at the wireless communications network, the wireless communications network (e.g., the last serving base station) may transmit a downlink transmission to the UE using the beam information after the UE returns to the RRC connected state. Accordingly, retaining the beam information may support a relatively faster return to the RRC connected state. The retained beam information may also support a reduced beam sweep overhead (e.g., when returning to the RRC connected state, when paging the UE) based on the retained information of the location and state of the UE (e.g., as reflected in the beam information).

Aspects of the disclosure are initially described in the context of wireless communications systems. Aspects of the disclosure are further illustrated by and described with reference to a process flow, apparatus diagrams, system diagrams, and flowcharts that relate to techniques for maintaining beam information in an inactive state.

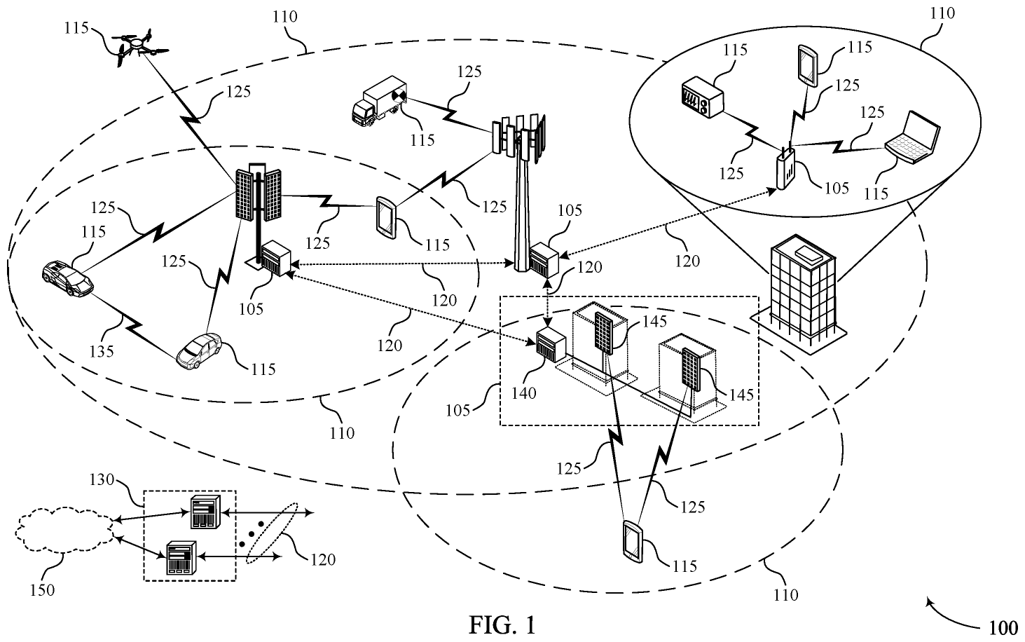

FIG. 1 illustrates an example of a wireless communications system 100 that supports techniques for maintaining beam information in an inactive state in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating states that reduce power consumption, such as half-duplex communications (e.g., a state that supports one-way communication via transmission or reception, but not transmission and reception simultaneously). In some examples, half-duplex communications may be performed at a reduced peak rate. Other power conservation techniques for the UEs 115 include entering a power saving deep sleep state when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

In an RRC inactive state, a UE 115 and a wireless communications network (e.g., one or more base stations 105, a core network 130) may retain beam information for the UE 115, in addition to other information (e.g., a connection management state, a registration management state). When in an RRC connected state, a serving base station 105 for the UE 115 may transmit an indication for the UE 115 to enter the inactive state. Based on the indication the UE 115 may maintain beam information at the UE 115, and the wireless communications network (e.g., one or more base stations 105, the core network 130) may also maintain the beam information. The UE 115 and the wireless communications network may also maintain one or more other contexts or states, such as a registration management state and a connection management state. Based on the beam information maintained in the inactive state, the wireless communication network may transmit paging messages for the UE 115 via one or more beams indicated by the beam information, while the UE 115 is in the inactive state.

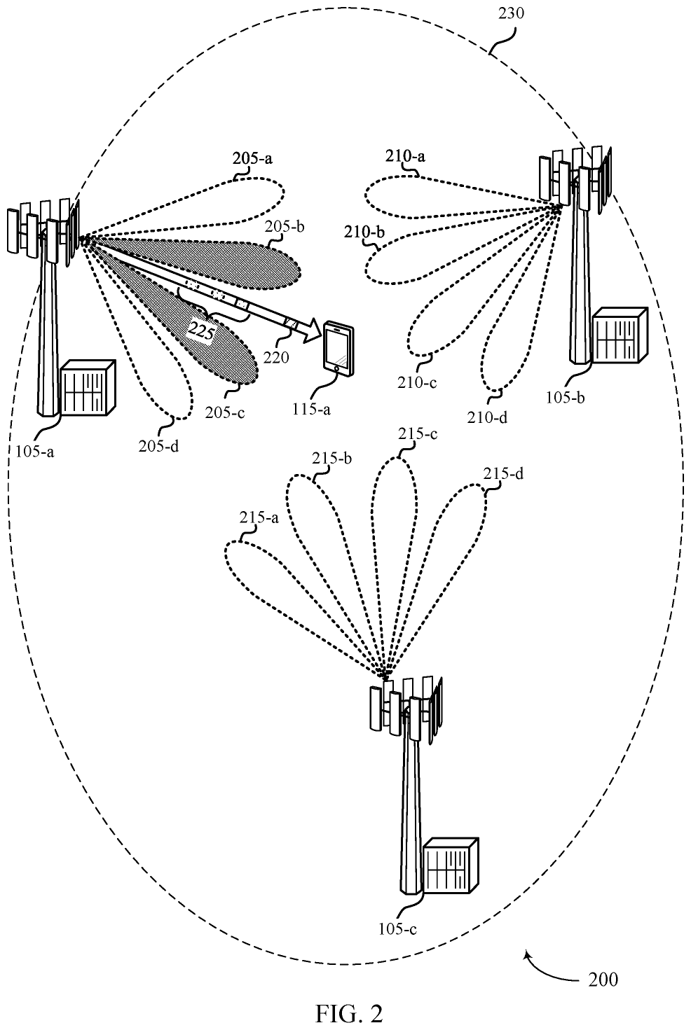

FIG. 2 illustrates an example of a wireless communications system 200 that supports techniques for maintaining beam information in an inactive state in accordance with aspects of the present disclosure. In some examples, wireless communications system 200 may implement or be implemented by one or more aspects of wireless communications system 100. For example, wireless communications system 200 may include a UE 115-a and base stations 105-a, 105-b, and 105-c (e.g., network devices), which may be examples of a UE 115 and base stations 105 described with reference to FIG. 1.

In some cases, UE 115-a may enter and exit a connected state with the wireless communications network (e.g., with one or more of base stations 105, with one or more network devices, with a core network). UE 115-a may exit the connected state, for example, to conserve network resources (e.g., to reserve resources for more active UEs 115) and to reduce power consumption at UE 115-a. The connected state may be an RRC state (e.g., a state for RRC communications with the network), and may be referred to herein as an RRC connected state. In some cases, when exiting the RRC connected state, UE 115-a may enter an RRC idle state (e.g., an idle state), in which one or more communications contexts associated with UE 115-a may be dropped (e.g., released, not retained or maintained) by the network. For example, a base station 105 (e.g., network device) serving UE 115-a (e.g., base station 105-a) may transmit an indication for UE 115-a to enter the RRC idle state (e.g., may indicate for UE 115-a to release its RRC connection).

In some cases, when exiting the RRC connected state, UE 115-a may enter an RRC inactive state (e.g., an inactive state, a second inactive state), which may be an intermediate state between the RRC connected state and the RRC idle state. For example, base station 105-a may transmit an indication for UE 115-a to enter the RRC inactive state (e.g., may indicate for UE 115-a to release and suspend its RRC connection). UE 115-a may exit the RRC inactive state to enter the RRC connected state (e.g., base station 105-a may indicate for UE 115-a to resume the RRC connected state) or may exit the RRC inactive state to enter the RRC idle state (e.g., base station 105-a may indicate for UE 115-a to fully release the RRC connected state).

In the RRC inactive state, one or more communications contexts or states associated with UE 115-a may be maintained by the network, which may reduce latency for re-entering the RRC connected state (e.g., may support a faster setup when re-entering the RRC connected state, or when switching back and forth between states). For example, to re-enter the RRC connected state, UE 115-a may transmit a request (e.g., to base station 105-a, 105-b, or 105-c) to resume an RRC connection. Based on the received request, the base station 105 may retrieve the maintained contexts from a last serving base station 105 (e.g., from base station 105-a) by transmitting a request to the last serving base station 105. Based on the retrieved contexts, the base station 105 may transmit an indication for UE 115-a to resume the RRC connected state, and UE 115-a may return to the RRC connected state. Upon returning to the RRC connected state, UE 115-a may indicate (e.g., to the base station 105) that UE 115-a has resumed the RRC connected state, upon which the base station 105 may request a path switch from the last serving base station 105 (e.g., from an AMF) and may indicate for the last serving base station to release the UE contexts.

The contexts maintained by the wireless communications network in the RRC inactive state may include registration and connection contexts, among other examples. For example, the wireless communications network (e.g., one or more base stations, the core network) may maintain a registration management state (e.g., an “RM-REGISTERED” state) for UE 115-a. The maintained registration management state may include a registration with the core network (e.g., 5G core (5GC) registration), a serving AMF and serving session management function (SMF) allocated to UE 115-a, an IP address allocated to UE 115-a, and a protocol data unit (PDU) session established for UE 115-a.

In the RRC inactive state, the wireless communications network (e.g., one or more base stations 105, the core network) may additionally or alternatively maintain a connection management state (e.g., a “CM_MANAGEMENT” state) for UE 115-a. The maintained connection management state may include an active status for UE 115-a, NAS signaling associated with UE 115-a, one or more quality of service (QOS) flows associated with UE 115-a, and an active user plane status for UE 115-a. In the RRC inactive state, the core network may also establish (e.g., or maintain) an NG radio access network (RAN) connection (e.g., user plane and control plane) for UE 115-a, where paging messages for UE 115-a may be initiated by the NG-RAN.

The NG-RAN may be aware of, or store information regarding, a RAN notification area (RNA) 230 to which UE 115-a belongs, which RNA 230 may be used for paging UE 115-a. The RNA 230 for UE 115-a may be configured by base station 105-a and may cover a single cell or multiple cells and may be within a CN registration area. Connectivity via one or more Xn links may be available within the RNA 230. When in the RRC inactive state, UE 115-a may update an RNA 230 with the network periodically or when UE 115-a is moving outside of the configured RNA 230. Paging in the RRC inactive state may be performed in the RNA 230, which may include multiple base stations 105. For example, an RNA 230 of UE 115-a may include base stations 105-a, 105-b, and 105-c.

Updating the RNA 230 in the RRC inactive state may follow a similar procedure to re-entering the RRC connected state. For example, UE 115-a may transmit a request (e.g., to a base station 105 in a new RNA 230) to resume an RRC connection, where the request may include a flag or indication for requesting an RNA 230 update. Based, on the request, the base station 105 may retrieve UE contexts (e.g., from a last serving base station 105), transmit a request to switch paths for UE 115-a, and transmit an indication for the last serving base station 105 to release the UE contexts. The base station 105 may also send (e.g., set) UE 115-a to an inactive state after retrieving the contexts, and may transmit an indication for UE 115-a to suspend its RRC connection (e.g., enter the RRC inactive state) after receiving an indication of the completion of the path switch (e.g., and before indicating for the last serving base station 105 to release the UE contexts).

In some cases, re-entering the RRC connected state from the RRC inactive state may experience some latency, for example, based on beam scanning overhead (e.g., in a sub-terahertz (THz) frequency range, where a total quantity of used beams may be relatively high). Additionally, an amount of paging overhead while UE 115-a is in the RRC inactive state may be relatively high, for example, based on using multiple base stations 105 and multiple beams for paging UE 115-a (e.g., for using an RNA 230 to page UE 115-a). For example, a paging overhead for UE 115-a in the RRC inactive state may be relatively high based on receiving paging messages via multiple beams (e.g., beams 205-a through 205-d, 210-a through 210-d, and 215-a through 215-d, or any combination thereof) from base stations 105-a, 105-b, and 105-c.

The present disclosure provides techniques for implementing an additional RRC inactive state (e.g., a first RRC inactive state) at UE 115-a, in which UE 115-a and the wireless communications network (e.g., one or more base stations 105, the core network) may retain beam information (e.g., a beam context, a spatial context) for UE 115-a, in addition to the other information retained by the network for the RRC inactive state (e.g., a connection management state, a registration management state). For example, in some cases, UE 115-a may retain (e.g., maintain) a last beam used (e.g., a receive beam), an orientation of the UE (e.g., to improve an initial beam guess, in case an orientation may have changed during an inactive period), one or more states for wireless communications (e.g., one or more transmission configuration indicator (TCI) states, automatic gain calibration (AGC) states, frequency and time tracking states), or any combination thereof. In some cases, the network (e.g., a base station) may retain similar information (e.g., the same information) as the UE, and in some cases, may retain additional information.

In some cases, the first RRC inactive state may be referred to as an RRC inactive localized state, for example, based on an associated movement state of UE 115-a (e.g., a low movement or localized state). The first RRC inactive state may additionally or alternatively be referred to as an intermediate state between the RRC inactive state (e.g., a second RRC inactive state) and the RRC connected state.

In one example, base station 105-a (e.g., a serving base station 105 for UE 115-a) may transmit an indication 220 for UE 115-a to enter the first RRC inactive state (e.g., based on one or more prior determinations or requests). Based on the indication UE 115-a may maintain beam information (e.g., paging beam information) at UE 115-a, and the wireless communications network (e.g., base station 105-a, the core network) may maintain the beam information. UE 115-a and the wireless communications network may also maintain one or more other contexts or states, such as a registration management state and a connection management state.

In some cases (e.g., in a sub-THz frequency use case), the beam information may be maintained (e.g., may stay valid while maintained) based on low mobility, low latency, higher data rate applications, or the like, for wireless communications at UE 115-a. The beam information may include one beam or multiple beams (e.g., multiple adjacent beams) to be used for paging UE 115-a, and may represent a last known beam or group of beams for downlink communications with UE 115-a. In some cases, retaining the beam information may include, or may be additionally or alternatively referred to as, retaining a context of one or more downlink beams for UE 115-a or retaining a beam association for UE 115-a. The RNA 230 of UE 115-a in the first RRC inactive state may include the beam(s) indicated by the beam information (e.g., as opposed to including base stations 105-a, 105-b, and 105-c).

Based on the beam information maintained in the first RRC inactive state, paging messages 225 for UE 115-a may be transmitted via one or more beams indicated by the beam information, instead of being transmitted via multiple beams from multiple base stations 105. For example, base station 105-a may transmit one or more paging messages 225 to UE 115-a via beams 205-b and 205-c (e.g., among other beams 205), which may be the beams indicated by the maintained beam information. Transmitting via a subset of beams (e.g., associated with one base station 105) may reduce paging overhead in terms of time, frequency, and/or spatial resources, among other examples, and may also reduce power consumption at UE 115-a in the first RRC inactive state (e.g., based on monitoring for paging messages using a reduced subset of beams).

UE 115-a may move from the first RRC inactive state to the RRC connected state, which may include similar procedures and signaling as those described herein for re-entering the RRC connected state from the RRC inactive state (e.g., second RRC inactive state). Similarly, and RNA 230 for UE 115-a may be updated using similar procedures and signaling as those described herein for updating the RNA 230 in the RRC inactive state (e.g., second RRC inactive state). In some cases, when updating the RNA 230 in the first RRC inactive state, the RNA update procedure may include updating the beam information stored at UE 115-a and/or at the wireless communications network.

UE 115-a may move from the first RRC inactive state to the RRC inactive state (e.g., the second RRC inactive state), for example, through a release procedure. In some cases, UE 115-a may change from the first RRC inactive state to the second RRC inactive state based on a value of a timer (e.g., a timeout or expiration of the timer) associated with the first RRC inactive state. In some other cases, UE 115-a may detect or sense a change in environment beam or other change (e.g., a change in location of UE 115-a) and may notify the network (e.g., base station 105-a or other base station 105) of the change. Based on the notification of the change, the network may release UE 115-a from the first RRC inactive state to the second RRC inactive state. In some cases, the network (e.g., base station 105-a) may also move or release UE 115-a from the first RRC inactive state to the second RRC inactive state based on a value of a timer (e.g., and UE 115-a may change states based on the indication of release from the network).

As described herein, UE 115-a may further move or change from the second RRC inactive state to the RRC idle state or to the RRC connected state. In some cases, UE 115-a may additionally or alternatively move or change from the first RRC inactive state to the RRC connected state. In some cases, based on the beam information (e.g., beam context) maintained at UE 115-a and at the wireless communications network, the wireless communications network (e.g., base station 105-a) may transmit a downlink transmission to UE 115-a using the beam information (e.g., using beams 205-b and 205-c, among other beams 205) after UE 115-a returns to the RRC connected state. Accordingly, retaining the beam information may support a relatively faster return to the RRC connected state. The retained beam information may also support a reduced beam sweep overhead (e.g., when returning to the RRC connected state, when paging UE 115-a) based on the retained information of the location and state of UE 115-a (e.g., as reflected in the beam information).

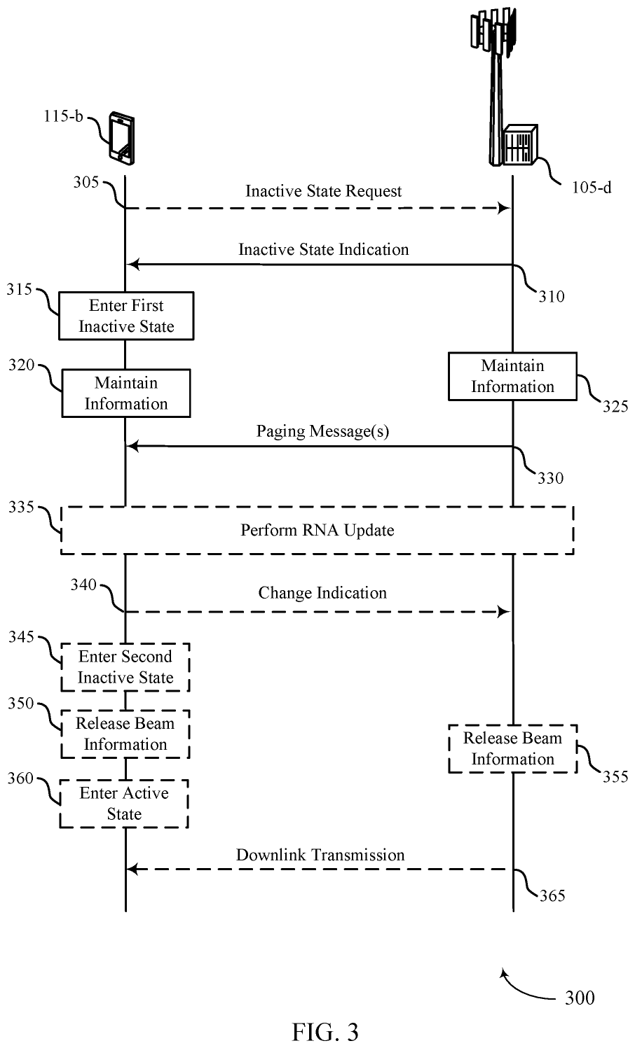

FIG. 3 illustrates an example of a process flow 300 that supports techniques for maintaining beam information in an inactive state in accordance with aspects of the present disclosure. In some examples, process flow may implement or be implemented by one or more aspects of wireless communications system 100 or 200. For example, process flow 300 may be implemented by a UE 115-b and a base station 105-d (e.g., a network device), which may be examples of a UE 115 and a base station 105 described with reference to FIGS. 1 and 2.

In the following description of process flow 300, the operations may be performed in a different order than the order shown, or the operations performed by UE 115-b and base station 105-d may be performed in different orders or at different times. For example, some operations may also be left out of process flow 300, or other operations may be added to process flow 300. Although UE 115-b and base station 105-d are shown performing the operations of process flow 300, some aspects of some operations may also be performed by one or more other wireless devices. For example, some actions shown as being performed by base station 105-d may be performed by another base station 105 or by a core network of a wireless communication network.

At 305, in some cases, UE 115-b may transmit a request to base station 105-d to enter an inactive state (e.g., a first inactive state) for RRC communications with a wireless communications network (e.g., that includes base station 105-d). The inactive state may represent the first RRC inactive state described with reference to FIG. 2, and may be associated with maintaining a registration management state, a connection management state, and beam information for UE 115-b at the wireless communications network. UE 115-b may transmit the request, for example, based on a movement state of UE 115-b (e.g., based on being in a low movement state, or relatively local state), a movement history of UE 115-b (e.g., which may indicate that UE 115-b is moving relatively slow or relatively infrequently), or any combination thereof.

At 310, base station 105-d may transmit, to UE 115-b, an indication to enter the first inactive state (e.g., for RRC communications with the wireless communications network). In some cases, base station 105-d may transmit the indication to enter the first inactive state based on a movement state of UE 115-b, a movement history of UE 115-b, or both. For example, UE 115-b may transmit an indication of such information to base station 105-d, or may request to enter the first inactive state based on such information, and base station 105-d may indicate for UE 115-b to enter the first inactive state based on the information received from UE 115-b, the request from UE 115-b, or both.

At 315, UE 115-b may enter the first inactive state based on receiving the indication from base station 105-d. Entering the first inactive state may include retaining (e.g., maintaining) the beam information at UE 115-b, where the beam information may include an indication of one or more downlink beams (e.g., last used downlink beam(s)) for paging UE 115-b in the first inactive state. For example, at 320, UE 115-b may maintain the beam information at UE 115-b based on entering the first inactive state

At 325, based on transmitting the indication to enter the first inactive state, base station 105-d may maintain a registration management state, a connection management state, and the beam information for UE 115-b at the wireless communications network. For example, base station 105-d may maintain such information (e.g., contexts, states, beam information) at base station 105-d or may perform one or more actions to maintain the information at a core network, or at another device or component (e.g., entity) of the wireless communications network.

At 330, base station 105-d may transmit, to UE 115-b in the first inactive state, one or more paging messages according to the beam information. For example, base station 105-d may use the one or more downlink beams indicated by the beam information for transmission of the one or more paging messages. Similarly, UE 115-b may monitor, within the first inactive state, for the one or more paging messages from base station 105-d, or another entity of the wireless communications network, according to the beam information retained at UE 115-b. For example, UE 115-b may monitor for the one or more paging messages using the one or more downlink beams indicated by the beam information.

At 335, in some cases, UE 115-b may perform an RNA update with the wireless communications network (e.g., with base station 105-d and/or another base station 105) while in the first inactive state. For example, UE 115-b may perform the RNA update (e.g., with base station 105-d and/or another base station 105) according to one or more procedures associated with RNA updates as described with reference to FIG. 2. Based on performing the RNA update, in some cases, UE 115-b and the wireless communications network may update the beam information retained at UE 115-b and the wireless communications network, respectively.

At 340, in some cases, UE 115-b may determine a change in a location of UE 115-b or a change in a beam of UE 115-b (e.g., in the first inactive state) and may transmit an indication of the change in location nor beam to base station 105-d. For example, as described with reference to FIG. 2, UE 115-b may detect a change in location or a change in an environment beam and may notify base station 105-d of the change.

In some cases, at 345, UE 115-b may enter a second inactive state, or may change from the first inactive state to the second inactive state. The second inactive state may represent a second RRC inactive state (e.g., the RRC inactive state) described with reference to FIG. 2, and may be associated with maintaining the registration management state and the connection management state for UE 115-b at the wireless communications network. Changing from the first inactive state to the second inactive state may include releasing the beam information stored at UE 115-b. Changing from the first inactive state to the second inactive state may be based on a change in location or beam of UE 115-b (e.g., a determined and reported at 335), or may be based on a value of a timer associated with the first inactive state (e.g., based on expiration of the timer).

As described with reference to FIG. 2, changing from the first inactive state to the second inactive state may, in some cases, be based on receiving an indication from base station 105-d to change from the first inactive state to the second inactive state. For example, based on the indication received from UE 115-b at 335, or based on the timer, base station 105-d may transmit an indication for UE 115-b to enter the second inactive state (e.g., an indication to release the first inactive state). Based on the indication, UE 115-b may enter the second inactive state and release the beam information. For example, UE 115-b may release the beam information at 350 based on entering the second inactive state.

Similarly, upon UE 115-b entering the second inactive state (e.g., upon notifying UE 115-b to enter the second inactive state, upon receiving an indication from UE 115-b that UE 115-b has entered the second inactive state), the wireless communications network (e.g., base station 105-d, another base station 105, the core network) may release the beam information, such as at 355. In some cases, UE 115-b may determine to enter the second inactive state and may enter the second inactive state (e.g., without receiving an indication from base station 105-b) and may notify base station 105-d that UE 115-b has entered the second inactive state and base station 105-d may release the beam information (e.g., at 355).

In some cases, as described with reference to FIG. 2, UE 115-b may additionally enter an idle state (e.g., an RRC idle state) from the second inactive state, for example, based on one or more conditions, or based on one or more indications from base station 105-d.

At 360, in some cases, UE 115-b may enter an active state, or may change to the active state for RRC communications with the wireless network. The active state may represent an RRC connected state as described with reference to FIG. 2. UE 115-b may enter the active state from the first inactive state, from the second inactive state, or from the idle state. In some cases, UE 115-b may enter the active state based on a request transmitted to base station 105-d, as described with reference to FIG. 2. For example, UE 115-b may perform one or more techniques described with reference to FIG. 2 for entering the active state from the first inactive state or from the second inactive state.

At 365, in some cases, base station 105-d (e.g., or another entity of the wireless communications network) may transmit, to UE 115-b, a downlink transmission that may be based on the beam information retained by UE 115-b and the wireless communications network during the first inactive state. For example, base station 105-d (e.g., or another entity) may transmit the downlink transmission to UE 115-b using the one or more downlink beams indicated by the beam information.

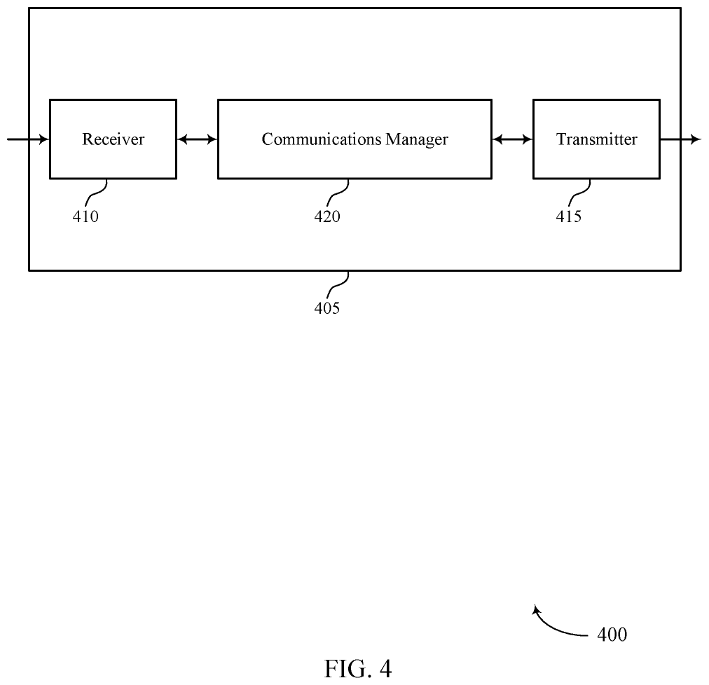

FIG. 4 shows a block diagram 400 of a device 405 that supports techniques for maintaining beam information in an inactive state in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for maintaining beam information in an inactive state). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for maintaining beam information in an inactive state). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for maintaining beam information in an inactive state as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving, from a network device, an indication to enter an inactive state for RRC communications with a wireless communications network, the inactive state associated with maintaining a registration management state, a connection management state, and beam information for the UE at the wireless communications network. The communications manager 420 may be configured as or otherwise support a means for entering the inactive state based on receiving the indication, where entering the inactive state includes retaining the beam information at the UE. The communications manager 420 may be configured as or otherwise support a means for monitoring, within the inactive state, for one or more paging messages from the wireless communications network according to the beam information.

The actions performed by the communications manager 420, among other examples herein, may be implemented to realize one or more potential advantages. For example, communications manager 420 may increase available battery power and communication quality at a wireless device (e.g., a UE 115) by supporting an inactive state associated with maintaining beam information, which may increase communication quality at the wireless device by supported beam-specific paging for the wireless device. The increase in communication quality may result in increased link performance and decreased overhead based on the beam-specific paging. Accordingly, communications manager 420 may save power and increase battery life at a wireless device (e.g., a UE 115) by strategically increasing a quality of communications at a wireless device (e.g., a UE 115).

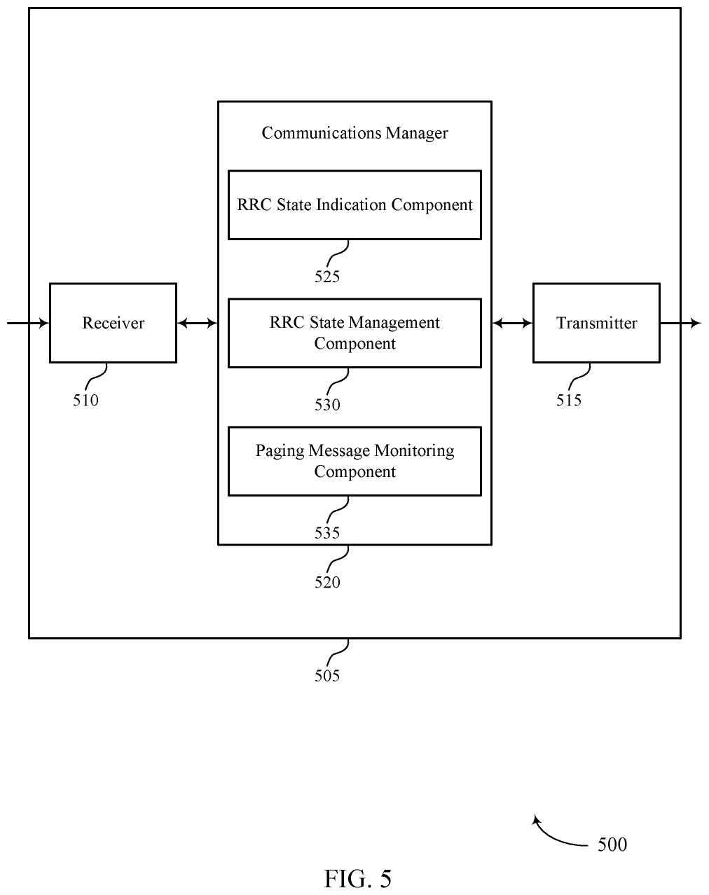

FIG. 5 shows a block diagram 500 of a device 505 that supports techniques for maintaining beam information in an inactive state in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for maintaining beam information in an inactive state). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for maintaining beam information in an inactive state). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for maintaining beam information in an inactive state as described herein. For example, the communications manager 520 may include an RRC state indication component 525, an RRC state management component 530, a paging message monitoring component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The RRC state indication component 525 may be configured as or otherwise support a means for receiving, from a network device, an indication to enter an inactive state for RRC communications with a wireless communications network, the inactive state associated with maintaining a registration management state, a connection management state, and beam information for the UE at the wireless communications network. The RRC state management component 530 may be configured as or otherwise support a means for entering the inactive state based on receiving the indication, where entering the inactive state includes retaining the beam information at the UE. The paging message monitoring component 535 may be configured as or otherwise support a means for monitoring, within the inactive state, for one or more paging messages from the wireless communications network according to the beam information.

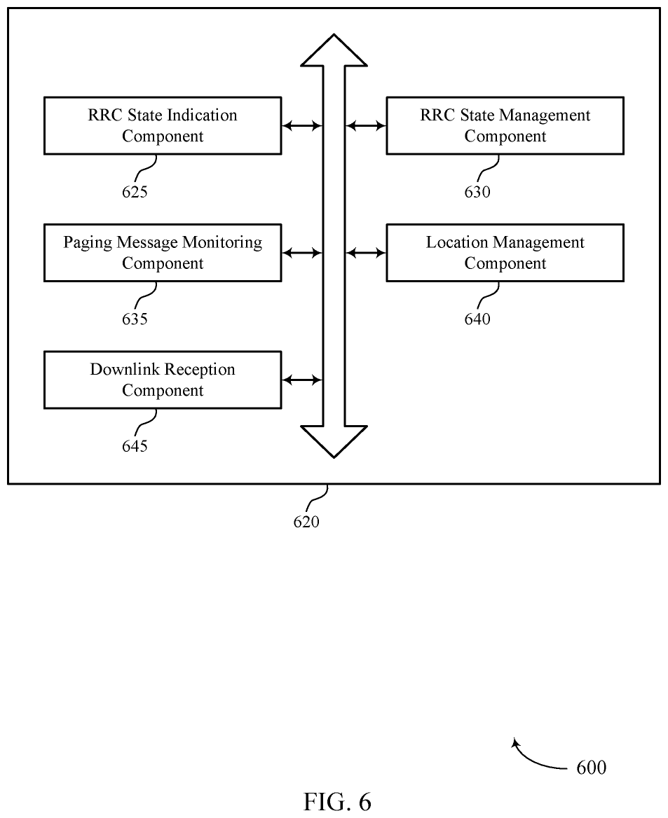

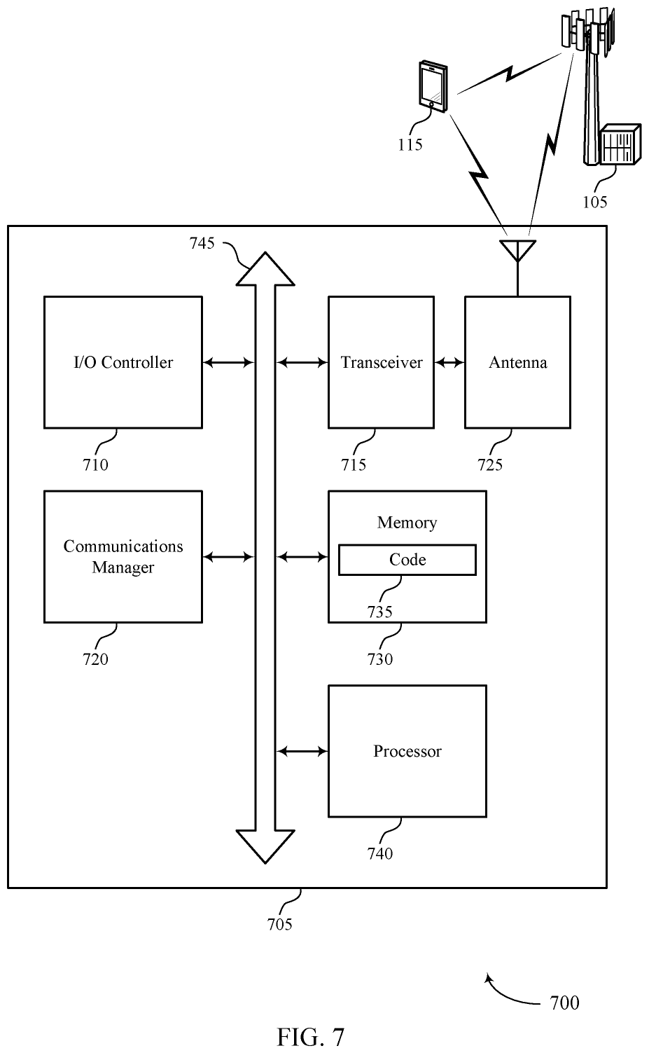

A processor of a wireless device (e.g., controlling the receiver 510, the transmitter 515, or the transceiver 715 as described with reference to FIG. 7) may increase available battery power and communication quality. The increased communication quality may increase available battery power and throughput (e.g., via implementation of system components described with reference to FIG. 6) compared to other systems and techniques, for example, that do not support maintenance of beam information in an inactive state. Further, the processor of the wireless device may identify one or more aspects of the inactive state and the associated beam information, which may result in increased communication quality, as well as save power and increase battery life at the wireless device (e.g., by strategically supporting beam-specific paging), among other benefits.

FIG. 6 shows a block diagram 600 of a communications manager 620 that supports techniques for maintaining beam information in an inactive state in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for maintaining beam information in an inactive state as described herein. For example, the communications manager 620 may include an RRC state indication component 625, an RRC state management component 630, a paging message monitoring component 635, a location management component 640, a downlink reception component 645, or any combination thereof. Each of these components may communicate, directly or indirectly, with one another (e.g., via one or more buses).

The communications manager 620 may support wireless communication at a UE in accordance with examples as disclosed herein. The RRC state indication component 625 may be configured as or otherwise support a means for receiving, from a network device, an indication to enter an inactive state for RRC communications with a wireless communications network, the inactive state associated with maintaining a registration management state, a connection management state, and beam information for the UE at the wireless communications network. The RRC state management component 630 may be configured as or otherwise support a means for entering the inactive state based on receiving the indication, where entering the inactive state includes retaining the beam information at the UE. The paging message monitoring component 635 may be configured as or otherwise support a means for monitoring, within the inactive state, for one or more paging messages from the wireless communications network according to the beam information.

In some examples, the RRC state management component 630 may be configured as or otherwise support a means for changing from the inactive state to a second inactive state that is associated with maintaining the registration management state and the connection management state for the UE at the wireless communications network, where changing from the inactive state to the second inactive state includes releasing the beam information at the UE.

In some examples, the location management component 640 may be configured as or otherwise support a means for determining a change in location of the UE or a change in a beam of the UE. In some examples, the location management component 640 may be configured as or otherwise support a means for transmitting, to the network device, an indication of the change in the location of the UE or the change in the beam of the UE based on determining the change in location or beam, where changing from the inactive state to the second inactive state is based on transmitting the indication of the change in location or beam to the network device. In some examples, changing from the inactive state to the second inactive state is based on a value of a timer associated with the inactive state.

In some examples, the RRC state management component 630 may be configured as or otherwise support a means for changing from the second inactive state to an active state for RRC communications with the wireless communications network. In some examples, the RRC state management component 630 may be configured as or otherwise support a means for changing from the inactive state to an active state for RRC communications with the wireless communications network.

In some examples, the downlink reception component 645 may be configured as or otherwise support a means for receiving, after changing from the inactive state to the active state, a downlink transmission from the wireless communications network based on the beam information retained at the UE.

In some examples, entering the inactive state is based on a movement state of the UE, a movement history of the UE, or any combination thereof. In some examples, the location management component 640 may be configured as or otherwise support a means for transmitting, to the network device, a request to enter the inactive state based on the movement state of the UE, the movement history of the UE, or any combination thereof, where receiving the indication to enter the inactive state is based on transmitting the request to enter the inactive state.

In some examples, the location management component 640 may be configured as or otherwise support a means for performing a RNA update with the wireless communications network while in the inactive state. In some examples, the RRC state management component 630 may be configured as or otherwise support a means for updating the beam information retained at the UE based on performing the RNA update. In some examples, the beam information includes an indication of one or more downlink beams for paging the UE in the inactive state.

FIG. 7 shows a diagram of a system 700 including a device 705 that supports techniques for maintaining beam information in an inactive state in accordance with aspects of the present disclosure. The device 705 may be an example of or include the components of a device 405, a device 505, or a UE 115 as described herein. The device 705 may communicate wirelessly with one or more network devices 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for maintaining beam information in an inactive state). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, from a network device, an indication to enter an inactive state for RRC communications with a wireless communications network, the inactive state associated with maintaining a registration management state, a connection management state, and beam information for the UE at the wireless communications network. The communications manager 720 may be configured as or otherwise support a means for entering the inactive state based on receiving the indication, where entering the inactive state includes retaining the beam information at the UE. The communications manager 720 may be configured as or otherwise support a means for monitoring, within the inactive state, for one or more paging messages from the wireless communications network according to the beam information.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for maintaining beam information in an inactive state as described herein, or the processor 740 and the memory 730 may be otherwise configured to perform or support such operations.

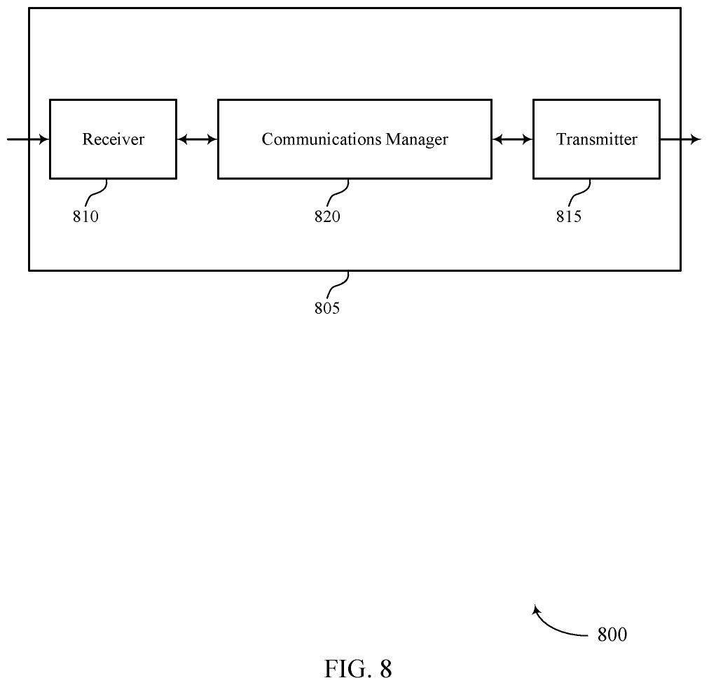

FIG. 8 shows a block diagram 800 of a device 805 that supports techniques for maintaining beam information in an inactive state in accordance with aspects of the present disclosure. The device 805 may be an example of aspects of a base station 105 (e.g., network device) as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for maintaining beam information in an inactive state). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for maintaining beam information in an inactive state). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for maintaining beam information in an inactive state as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a network device in accordance with examples as disclosed herein. For example, the communications manager 820 may be configured as or otherwise support a means for transmitting an indication for a UE to enter an inactive state for RRC communications with a wireless communications network, the inactive state associated with retaining beam information at the UE. The communications manager 820 may be configured as or otherwise support a means for maintaining a registration management state, a connection management state, and the beam information for the UE at the wireless communications network based on transmitting the indication to enter the inactive state. The communications manager 820 may be configured as or otherwise support a means for transmitting, for the UE in the inactive state, one or more paging messages according to the beam information.

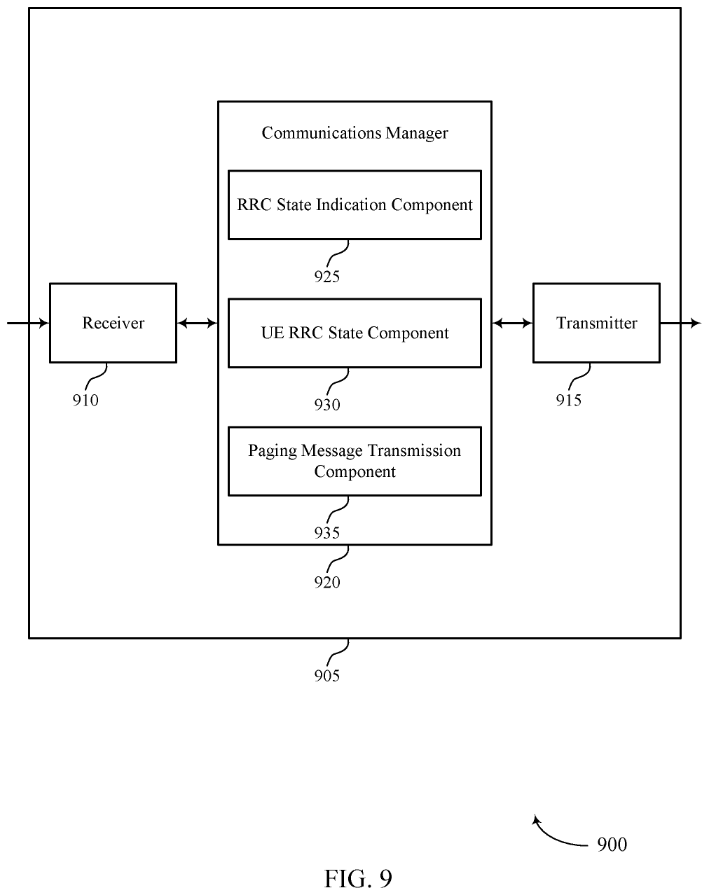

FIG. 9 shows a block diagram 900 of a device 905 that supports techniques for maintaining beam information in an inactive state in accordance with aspects of the present disclosure. The device 905 may be an example of aspects of a device 805 or a base station 105 (e.g., network device) as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for maintaining beam information in an inactive state). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for maintaining beam information in an inactive state). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for maintaining beam information in an inactive state as described herein. For example, the communications manager 920 may include an RRC state indication component 925, a UE RRC state component 930, a paging message transmission component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network device in accordance with examples as disclosed herein. The RRC state indication component 925 may be configured as or otherwise support a means for transmitting an indication for a UE to enter an inactive state for RRC communications with a wireless communications network, the inactive state associated with retaining beam information at the UE. The UE RRC state component 930 may be configured as or otherwise support a means for maintaining a registration management state, a connection management state, and the beam information for the UE at the wireless communications network based on transmitting the indication to enter the inactive state. The paging message transmission component 935 may be configured as or otherwise support a means for transmitting, for the UE in the inactive state, one or more paging messages according to the beam information.

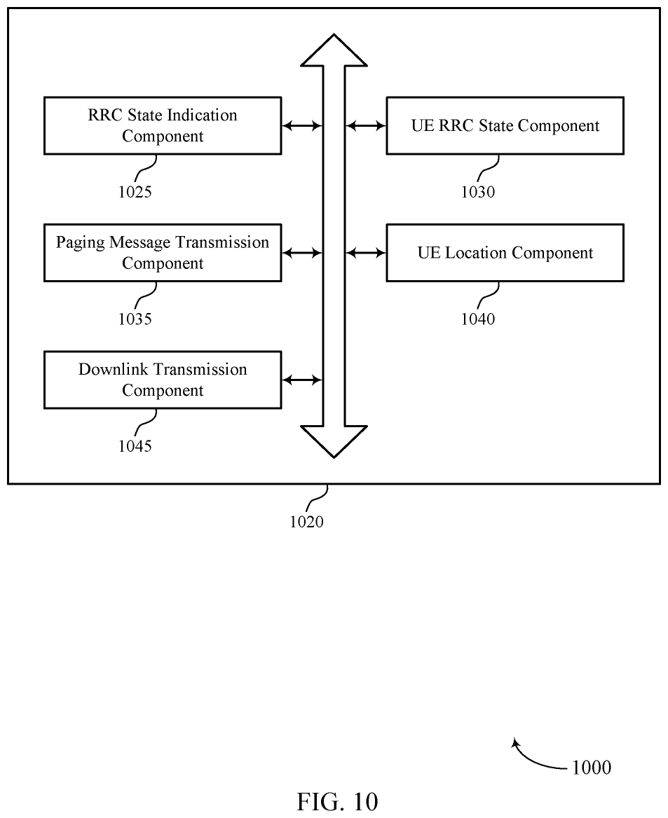

FIG. 10 shows a block diagram 1000 of a communications manager 1020 that supports techniques for maintaining beam information in an inactive state in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for maintaining beam information in an inactive state as described herein. For example, the communications manager 1020 may include an RRC state indication component 1025, a UE RRC state component 1030, a paging message transmission component 1035, a UE location component 1040, a downlink transmission component 1045, or any combination thereof. Each of these components may communicate, directly or indirectly, with one another (e.g., via one or more buses).

The communications manager 1020 may support wireless communication at a network device in accordance with examples as disclosed herein. The RRC state indication component 1025 may be configured as or otherwise support a means for transmitting an indication for a UE to enter an inactive state for RRC communications with a wireless communications network, the inactive state associated with retaining beam information at the UE. The UE RRC state component 1030 may be configured as or otherwise support a means for maintaining a registration management state, a connection management state, and the beam information for the UE at the wireless communications network based on transmitting the indication to enter the inactive state. The paging message transmission component 1035 may be configured as or otherwise support a means for transmitting, for the UE in the inactive state, one or more paging messages according to the beam information.

In some examples, the UE RRC state component 1030 may be configured as or otherwise support a means for updating the UE from the inactive state to a second inactive state at the wireless communications network, where updating the UE from the inactive state to the second inactive state includes releasing the beam information for the UE from the wireless communications network and maintaining the registration management state and the connection management state for the UE at the wireless communications network.

In some examples, the UE location component 1040 may be configured as or otherwise support a means for receiving an indication of a change in a location of the UE or a change in a beam of the UE, where updating the UE from the inactive state to the second inactive state is based on receiving the indication of the change in location or beam. In some examples, updating the UE from the inactive state to the second inactive state is based on a value of a timer associated with the inactive state.

In some examples, the UE RRC state component 1030 may be configured as or otherwise support a means for updating the UE from the second inactive state to an active state for RRC communications with the wireless communications network. In some examples, the UE RRC state component 1030 may be configured as or otherwise support a means for updating the UE from the inactive state to an active state for RRC communications with the wireless communications network.

In some examples, the downlink transmission component 1045 may be configured as or otherwise support a means for transmitting, after updating the UE from the inactive state to the active state, a downlink transmission based on the beam information retained at the wireless communications network.

In some examples, transmitting the indication to enter the inactive state is based on a movement state of the UE, a movement history of the UE, or any combination thereof. In some examples, the UE location component 1040 may be configured as or otherwise support a means for receiving a request to enter the inactive state at the UE based on the movement state of the UE, the movement history of the UE, or any combination thereof, where transmitting the indication to enter the inactive state is based on receiving the request to enter the inactive state.

In some examples, the UE location component 1040 may be configured as or otherwise support a means for performing an RNA update with the UE in the inactive state. In some examples, the UE RRC state component 1030 may be configured as or otherwise support a means for updating the beam information for the UE at the wireless communications network based on performing the RNA update. In some examples, the beam information includes an indication of one or more downlink beams for paging the UE in the inactive state.

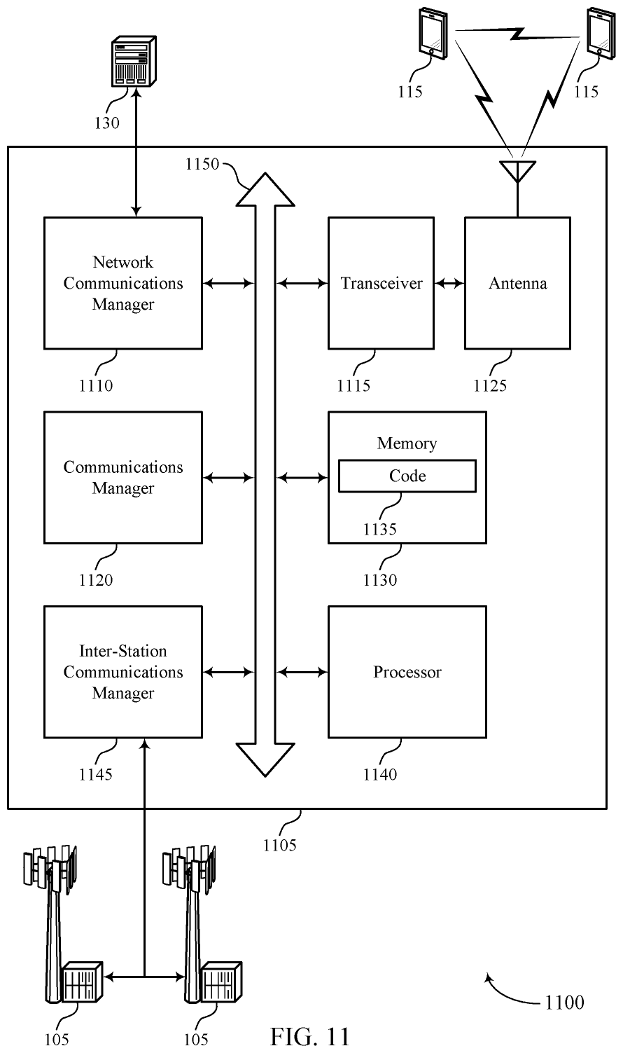

FIG. 11 shows a diagram of a system 1100 including a device 1105 that supports techniques for maintaining beam information in an inactive state in accordance with aspects of the present disclosure. The device 1105 may be an example of or include the components of a device 805, a device 905, or a base station 105 (e.g., network device) as described herein. The device 1105 may communicate wirelessly with one or more base stations 105 (e.g., network devices), UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for maintaining beam information in an inactive state). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other base stations 105 (e.g., network devices), and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a network device in accordance with examples as disclosed herein. For example, the communications manager 1120 may be configured as or otherwise support a means for transmitting an indication for a UE to enter an inactive state for RRC communications with a wireless communications network, the inactive state associated with retaining beam information at the UE. The communications manager 1120 may be configured as or otherwise support a means for maintaining a registration management state, a connection management state, and the beam information for the UE at the wireless communications network based on transmitting the indication to enter the inactive state. The communications manager 1120 may be configured as or otherwise support a means for transmitting, for the UE in the inactive state, one or more paging messages according to the beam information.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for maintaining beam information in an inactive state as described herein, or the processor 1140 and the memory 1130 may be otherwise configured to perform or support such operations.

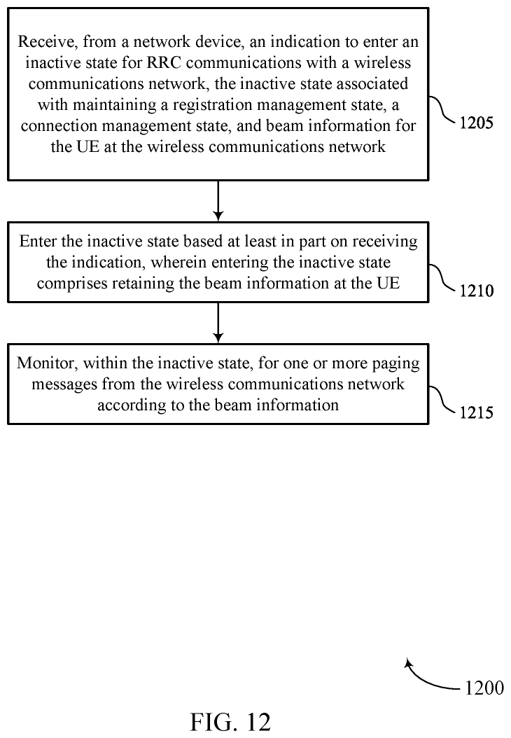

FIG. 12 shows a flowchart illustrating a method 1200 that supports techniques for maintaining beam information in an inactive state in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a network device, an indication to enter an inactive state for RRC communications with a wireless communications network, the inactive state associated with maintaining a registration management state, a connection management state, and beam information for the UE at the wireless communications network. The operations of 1205 may be performed in accordance with examples as disclosed herein. In some examples, aspects of the operations of 1205 may be performed by an RRC state indication component 625 as described with reference to FIG. 6.

At 1210, the method may include entering the inactive state based at least in part on receiving the indication, wherein entering the inactive state comprises retaining the beam information at the UE. The operations of 1210 may be performed in accordance with examples as disclosed herein. In some examples, aspects of the operations of 1210 may be performed by an RRC state management component 630 as described with reference to FIG. 6.

At 1215, the method may include monitoring, within the inactive state, for one or more paging messages from the wireless communications network according to the beam information. The operations of 1215 may be performed in accordance with examples as disclosed herein. In some examples, aspects of the operations of 1215 may be performed by a paging message monitoring component 635 as described with reference to FIG. 6.

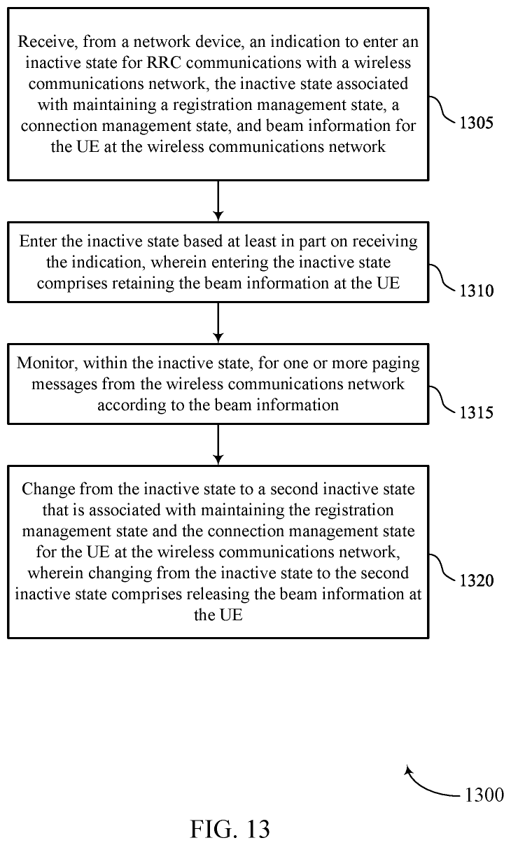

FIG. 13 shows a flowchart illustrating a method 1300 that supports techniques for maintaining beam information in an inactive state in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a network device, an indication to enter an inactive state for RRC communications with a wireless communications network, the inactive state associated with maintaining a registration management state, a connection management state, and beam information for the UE at the wireless communications network. The operations of 1305 may be performed in accordance with examples as disclosed herein. In some examples, aspects of the operations of 1305 may be performed by an RRC state indication component 625 as described with reference to FIG. 6.

At 1310, the method may include entering the inactive state based at least in part on receiving the indication, wherein entering the inactive state comprises retaining the beam information at the UE. The operations of 1310 may be performed in accordance with examples as disclosed herein. In some examples, aspects of the operations of 1310 may be performed by an RRC state management component 630 as described with reference to FIG. 6.

At 1315, the method may include monitoring, within the inactive state, for one or more paging messages from the wireless communications network according to the beam information. The operations of 1315 may be performed in accordance with examples as disclosed herein. In some examples, aspects of the operations of 1315 may be performed by a paging message monitoring component 635 as described with reference to FIG. 6.

At 1320, the method may include changing from the inactive state to a second inactive state that is associated with maintaining the registration management state and the connection management state for the UE at the wireless communications network, wherein changing from the inactive state to the second inactive state comprises releasing the beam information at the UE. The operations of 1320 may be performed in accordance with examples as disclosed herein. In some examples, aspects of the operations of 1320 may be performed by an RRC state management component 630 as described with reference to FIG. 6.

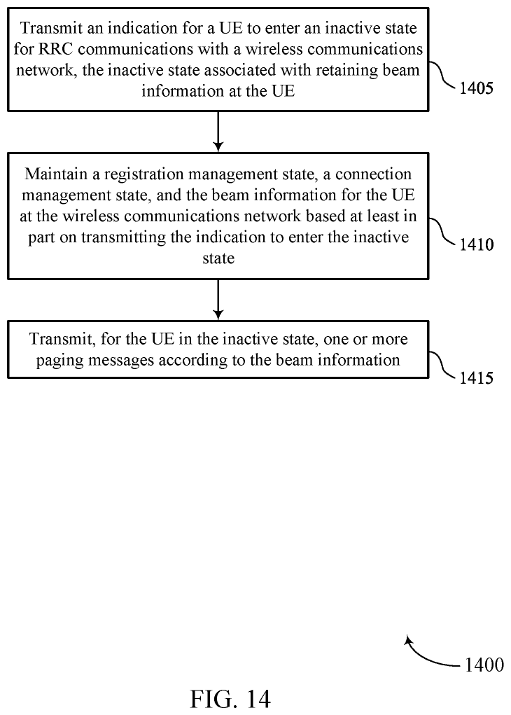

FIG. 14 shows a flowchart illustrating a method 1400 that supports techniques for maintaining beam information in an inactive state in accordance with aspects of the present disclosure. The operations of the method 1400 may be implemented by a base station or its components as described herein. For example, the operations of the method 1400 may be performed by a base station 105 (e.g., network device) as described with reference to FIGS. 1 through 3 and 8 through 11. In some examples, a network device may execute a set of instructions to control the functional elements of the network device to perform the described functions. Additionally or alternatively, the network device may perform aspects of the described functions using special-purpose hardware.

At 1405, the method may include transmitting an indication for a UE to enter an inactive state for RRC communications with a wireless communications network, the inactive state associated with retaining beam information at the UE. The operations of 1405 may be performed in accordance with examples as disclosed herein. In some examples, aspects of the operations of 1405 may be performed by an RRC state indication component 1025 as described with reference to FIG. 10.

At 1410, the method may include maintaining a registration management state, a connection management state, and the beam information for the UE at the wireless communications network based at least in part on transmitting the indication to enter the inactive state. The operations of 1410 may be performed in accordance with examples as disclosed herein. In some examples, aspects of the operations of 1410 may be performed by a UE RRC state component 1030 as described with reference to FIG. 10.

At 1415, the method may include transmitting, for the UE in the inactive state, one or more paging messages according to the beam information. The operations of 1415 may be performed in accordance with examples as disclosed herein. In some examples, aspects of the operations of 1415 may be performed by a paging message transmission component 1035 as described with reference to FIG. 10.

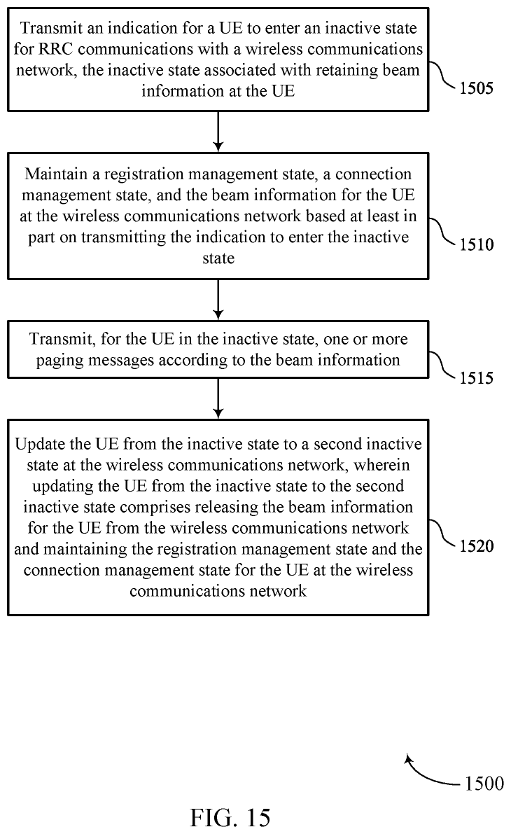

FIG. 15 shows a flowchart illustrating a method 1500 that supports techniques for maintaining beam information in an inactive state in accordance with aspects of the present disclosure. The operations of the method 1500 may be implemented by a base station or its components as described herein. For example, the operations of the method 1500 may be performed by a base station 105 (e.g., network device) as described with reference to FIGS. 1 through 3 and 8 through 11. In some examples, a network device may execute a set of instructions to control the functional elements of the network device to perform the described functions. Additionally or alternatively, the network device may perform aspects of the described functions using special-purpose hardware.

At 1505, the method may include transmitting an indication for a UE to enter an inactive state for RRC communications with a wireless communications network, the inactive state associated with retaining beam information at the UE. The operations of 1505 may be performed in accordance with examples as disclosed herein. In some examples, aspects of the operations of 1505 may be performed by an RRC state indication component 1025 as described with reference to FIG. 10.

At 1510, the method may include maintaining a registration management state, a connection management state, and the beam information for the UE at the wireless communications network based at least in part on transmitting the indication to enter the inactive state. The operations of 1510 may be performed in accordance with examples as disclosed herein. In some examples, aspects of the operations of 1510 may be performed by a UE RRC state component 1030 as described with reference to FIG. 10.

At 1515, the method may include transmitting, for the UE in the inactive state, one or more paging messages according to the beam information. The operations of 1515 may be performed in accordance with examples as disclosed herein. In some examples, aspects of the operations of 1515 may be performed by a paging message transmission component 1035 as described with reference to FIG. 10.

At 1520, the method may include updating the UE from the inactive state to a second inactive state at the wireless communications network, wherein updating the UE from the inactive state to the second inactive state comprises releasing the beam information for the UE from the wireless communications network and maintaining the registration management state and the connection management state for the UE at the wireless communications network. The operations of 1520 may be performed in accordance with examples as disclosed herein. In some examples, aspects of the operations of 1520 may be performed by a UE RRC state component 1030 as described with reference to FIG. 10.

The following provides an overview of aspects of the present disclosure:

Aspect 1: A method for wireless communication at a UE, comprising: receiving, from a network device, an indication to enter an inactive state for RRC communications with a wireless communications network, the inactive state associated with maintaining a registration management state, a connection management state, and beam information for the UE at the wireless communications network; entering the inactive state based at least in part on receiving the indication, wherein entering the inactive state comprises retaining the beam information at the UE; and monitoring, within the inactive state, for one or more paging messages from the wireless communications network according to the beam information.

Aspect 2: The method of aspect 1, further comprising: changing from the inactive state to a second inactive state that is associated with maintaining the registration management state and the connection management state for the UE at the wireless communications network, wherein changing from the inactive state to the second inactive state comprises releasing the beam information at the UE.

Aspect 3: The method of aspect 2, further comprising: determining a change in location of the UE or a change in a beam of the UE; and transmitting, to the network device, an indication of the change in the location of the UE or the change in the beam of the UE based at least in part on determining the change in location or beam, wherein changing from the inactive state to the second inactive state is based at least in part on transmitting the indication of the change in location or beam to the network device.

Aspect 4: The method of any of aspects 2 through 3, wherein changing from the inactive state to the second inactive state is based at least in part on a value of a timer associated with the inactive state.

Aspect 5: The method of any of aspects 2 through 4, further comprising: changing from the second inactive state to an active state for RRC communications with the wireless communications network.

Aspect 6: The method of aspect 1, further comprising: changing from the inactive state to an active state for RRC communications with the wireless communications network.

Aspect 7: The method of aspect 6, further comprising: receiving, after changing from the inactive state to the active state, a downlink transmission from the wireless communications network based at least in part on the beam information retained at the UE.

Aspect 8: The method of any of aspects 1 through 7, wherein entering the inactive state is based at least in part on a movement state of the UE, a movement history of the UE, or any combination thereof.

Aspect 9: The method of aspect 8, further comprising: transmitting, to the network device, a request to enter the inactive state based at least in part on the movement state of the UE, the movement history of the UE, or any combination thereof, wherein receiving the indication to enter the inactive state is based at least in part on transmitting the request to enter the inactive state.

Aspect 10: The method of any of aspects 1 through 9, further comprising: performing a RAN update with the wireless communications network while in the inactive state; and updating the beam information retained at the UE based at least in part on performing the RAN update.

Aspect 11: The method of any of aspects 1 through 10, wherein the beam information comprises an indication of one or more downlink beams for paging the UE in the inactive state.

Aspect 12: A method for wireless communication at a network device, comprising: transmitting an indication for a UE to enter an inactive state for RRC communications with a wireless communications network, the inactive state associated with retaining beam information at the UE; maintaining a registration management state, a connection management state, and the beam information for the UE at the wireless communications network based at least in part on transmitting the indication to enter the inactive state; and transmitting, for the UE in the inactive state, one or more paging messages according to the beam information.

Aspect 13: The method of aspect 12, further comprising: updating the UE from the inactive state to a second inactive state at the wireless communications network, wherein updating the UE from the inactive state to the second inactive state comprises releasing the beam information for the UE from the wireless communications network and maintaining the registration management state and the connection management state for the UE at the wireless communications network.

Aspect 14: The method of aspect 13, further comprising: receiving an indication of a change in a location of the UE or a change in a beam of the UE, wherein updating the UE from the inactive state to the second inactive state is based at least in part on receiving the indication of the change in location or beam.

Aspect 15: The method of any of aspects 13 through 14, wherein updating the UE from the inactive state to the second inactive state is based at least in part on a value of a timer associated with the inactive state.

Aspect 16: The method of any of aspects 13 through 15, further comprising: updating the UE from the second inactive state to an active state for RRC communications with the wireless communications network.

Aspect 17: The method of aspect 12, further comprising: updating the UE from the inactive state to an active state for RRC communications with the wireless communications network.

Aspect 18: The method of aspect 17, further comprising: transmitting, after updating the UE from the inactive state to the active state, a downlink transmission based at least in part on the beam information retained at the wireless communications network.

Aspect 19: The method of any of aspects 12 through 18, wherein transmitting the indication to enter the inactive state is based at least in part on a movement state of the UE, a movement history of the UE, or any combination thereof.

Aspect 20: The method of aspect 19, further comprising: receiving a request to enter the inactive state at the UE based at least in part on the movement state of the UE, the movement history of the UE, or any combination thereof, wherein transmitting the indication to enter the inactive state is based at least in part on receiving the request to enter the inactive state.

Aspect 21: The method of any of aspects 12 through 20, further comprising: performing a RAN update with the UE in the inactive state; and updating the beam information for the UE at the wireless communications network based at least in part on performing the RAN update.

Aspect 22: The method of any of aspects 12 through 21, wherein the beam information comprises an indication of one or more downlink beams for paging the UE in the inactive state.

Aspect 23: An apparatus for wireless communication at a UE, comprising a processor and a memory coupled with the processor, wherein the memory comprises instructions executable by the processor to cause the apparatus to perform a method of any of aspects 1 through 11.

Aspect 24: An apparatus for wireless communication at a UE, comprising at least one means for performing a method of any of aspects 1 through 11.

Aspect 25: A non-transitory computer-readable medium storing code for wireless communication at a UE, wherein the code comprises instructions executable by a processor to perform a method of any of aspects 1 through 11.

Aspect 26: An apparatus for wireless communication at a network device, comprising a processor and a memory coupled with the processor, wherein the memory comprises instructions executable by the processor to cause the apparatus to perform a method of any of aspects 12 through 22.

Aspect 27: An apparatus for wireless communication at a network device, comprising at least one means for performing a method of any of aspects 12 through 22.

Aspect 28: A non-transitory computer-readable medium storing code for wireless communication at a network device, wherein the code comprises instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network device, an indication to enter an inactive state for radio resource control communications with a wireless communications network, the inactive state associated with maintaining a registration management state, a connection management state, and beam information for the UE at the wireless communications network;
entering the inactive state based at least in part on receiving the indication, wherein entering the inactive state comprises retaining the beam information at the UE; and
monitoring, within the inactive state, for one or more paging messages from the wireless communications network according to the beam information.

2. The method of claim 1, further comprising:
changing from the inactive state to a second inactive state that is associated with maintaining the registration management state and the connection management state for the UE at the wireless communications network, wherein changing from the inactive state to the second inactive state comprises releasing the beam information at the UE.

3. The method of claim 2, further comprising:
determining a change in location of the UE or a change in a beam of the UE; and
transmitting, to the network device, an indication of the change in the location of the UE or the change in the beam of the UE based at least in part on determining the change in location or beam, wherein changing from the inactive state to the second inactive state is based at least in part on transmitting the indication of the change in location or beam to the network device.

4. The method of claim 2, wherein changing from the inactive state to the second inactive state is based at least in part on a value of a timer associated with the inactive state.

5. The method of claim 2, further comprising:
changing from the second inactive state to an active state for radio resource control communications with the wireless communications network.

6. The method of claim 1, further comprising:
changing from the inactive state to an active state for radio resource control communications with the wireless communications network.

7. The method of claim 6, further comprising:
receiving, after changing from the inactive state to the active state, a downlink transmission from the wireless communications network based at least in part on the beam information retained at the UE.

8. The method of claim 1, wherein entering the inactive state is based at least in part on a movement state of the UE, a movement history of the UE, or any combination thereof.

9. The method of claim 8, further comprising:
transmitting, to the network device, a request to enter the inactive state based at least in part on the movement state of the UE, the movement history of the UE, or any combination thereof, wherein receiving the indication to enter the inactive state is based at least in part on transmitting the request to enter the inactive state.

10. The method of claim 1, further comprising:
performing a radio access network notification area update with the wireless communications network while in the inactive state; and
updating the beam information retained at the UE based at least in part on performing the radio access network notification area update.

11. The method of claim 1, wherein the beam information comprises an indication of one or more downlink beams for paging the UE in the inactive state.

12. A method for wireless communication at a network device, comprising:
transmitting an indication for a user equipment (UE) to enter an inactive state for radio resource control communications with a wireless communications network, the inactive state associated with retaining beam information at the UE;
maintaining a registration management state, a connection management state, and the beam information for the UE at the wireless communications network based at least in part on transmitting the indication to enter the inactive state; and
transmitting, for the UE in the inactive state, one or more paging messages according to the beam information.

13. The method of claim 12, further comprising:
updating the UE from the inactive state to a second inactive state at the wireless communications network, wherein updating the UE from the inactive state to the second inactive state comprises releasing the beam information for the UE from the wireless communications network and maintaining the registration management state and the connection management state for the UE at the wireless communications network.

14. The method of claim 13, further comprising:
receiving an indication of a change in a location of the UE or a change in a beam of the UE, wherein updating the UE from the inactive state to the second inactive state is based at least in part on receiving the indication of the change in location or beam.

15. The method of claim 13, wherein updating the UE from the inactive state to the second inactive state is based at least in part on a value of a timer associated with the inactive state.

16. The method of claim 13, further comprising:
updating the UE from the second inactive state to an active state for radio resource control communications with the wireless communications network.

17. The method of claim 12, further comprising:
updating the UE from the inactive state to an active state for radio resource control communications with the wireless communications network.

18. The method of claim 17, further comprising:
transmitting, after updating the UE from the inactive state to the active state, a downlink transmission based at least in part on the beam information retained at the wireless communications network.

19. The method of claim 12, wherein transmitting the indication to enter the inactive state is based at least in part on a movement state of the UE, a movement history of the UE, or any combination thereof.

20. The method of claim 19, further comprising:
receiving a request to enter the inactive state at the UE based at least in part on the movement state of the UE, the movement history of the UE, or any combination thereof, wherein transmitting the indication to enter the inactive state is based at least in part on receiving the request to enter the inactive state.

21. The method of claim 12, further comprising:
performing a radio access network notification area update with the UE in the inactive state; and
updating the beam information for the UE at the wireless communications network based at least in part on performing the radio access network notification area update.

22. The method of claim 12, wherein the beam information comprises an indication of one or more downlink beams for paging the UE in the inactive state.

23. An apparatus for wireless communication at a user equipment (UE), comprising:
a processor; and
a memory coupled with the processor, wherein the memory comprises instructions executable by the processor to cause the apparatus to:
receive, from a network device, an indication to enter an inactive state for radio resource control communications with a wireless communications network, the inactive state associated with maintaining a registration management state, a connection management state, and beam information for the UE at the wireless communications network;
enter the inactive state based at least in part on receiving the indication, wherein entering the inactive state comprises retaining the beam information at the UE; and
monitor, within the inactive state, for one or more paging messages from the wireless communications network according to the beam information.

24. The apparatus of claim 23, wherein the instructions are further executable by the processor to cause the apparatus to:
change from the inactive state to a second inactive state that is associated with maintaining the registration management state and the connection management state for the UE at the wireless communications network, wherein changing from the inactive state to the second inactive state comprises releasing the beam information at the UE.

25. The apparatus of claim 23, wherein the instructions are further executable by the processor to cause the apparatus to:
change from the inactive state to an active state for radio resource control communications with the wireless communications network.

26. The apparatus of claim 25, wherein the instructions are further executable by the processor to cause the apparatus to:
receive, after changing from the inactive state to the active state, a downlink transmission from the wireless communications network based at least in part on the beam information retained at the UE.

27. An apparatus for wireless communication at a network device, comprising:
a processor; and
a memory coupled with the processor, wherein the memory comprises instructions executable by the processor to cause the apparatus to:
transmit an indication for a user equipment (UE) to enter an inactive state for radio resource control communications with a wireless communications network, the inactive state associated with retaining beam information at the UE;
maintain a registration management state, a connection management state, and the beam information for the UE at the wireless communications network based at least in part on transmitting the indication to enter the inactive state; and
transmit, for the UE in the inactive state, one or more paging messages according to the beam information.

28. The apparatus of claim 27, wherein the instructions are further executable by the processor to cause the apparatus to:
update the UE from the inactive state to a second inactive state at the wireless communications network, wherein updating the UE from the inactive state to the second inactive state comprises releasing the beam information for the UE from the wireless communications network and maintaining the registration management state and the connection management state for the UE at the wireless communications network.

29. The apparatus of claim 27, wherein the instructions are further executable by the processor to cause the apparatus to:
update the UE from the inactive state to an active state for radio resource control communications with the wireless communications network.

30. The apparatus of claim 29, wherein the instructions are further executable by the processor to cause the apparatus to:
transmit, after updating the UE from the inactive state to the active state, a downlink transmission based at least in part on the beam information retained at the wireless communications network.
